(19) United States
(12) Patent Application Publication
(10) Pub. No.: US 2026/0346717 A1
(43) Pub. Date: Nov. 5, 2026

(54) MOBILE BODY DISPLAY SYSTEM

(71) Applicant: Nippon Seiki Co., Ltd., Niigata (JP)

(72) Inventor: Naoyuki SHIRAISHI, Niigata (JP)

(21) Appl. No.: 19/487,106

(22) PCT Filed: Jun. 24, 2024
(86) PCT No.: PCT/JP2024/022762

§ 371 Date: Nov. 24, 2025

(30) Foreign Application Priority Data
Jun. 27, 2023 (JP) 2023-104762

(51) Int. Cl. B60K 35/233; G09G 3/00

(52) U.S. Cl. CPC B60K 35/233; G09G 3/001; G09G 2340/0464; G09G 2380/10

(57) ABSTRACT

Please replace the abstract in the specification as filed with the below paragraph as follows:

A mobile body display system makes a display unit display an image such that the image is superimposed over an actual view. The mobile body display system comprises an information acquisition means that acquires angular velocity information and acceleration information, a control means that configures correction information for correcting the display position of the image on the basis of an angular velocity from the angular velocity information and an acceleration from the acceleration information as acquired a prescribed time before the time at which the angular velocity information is acquired, and a display position adjustment means that adjusts the display position of the image on the basis of the correction information.

### TECHNICAL FIELD

The present disclosure relates to a mobile body display system that superimposes an image (a virtual object) on an actual view on the traveling direction side of a mobile body.

### BACKGROUND ART

Mobile body display systems have been developed that can display, for example, during driving of a mobile body such as a vehicle, driving assistance information on a windshield or the like on the front side of the vehicle (in the traveling direction of the vehicle). A head up display (HUD) device is known as an example of a mobile body display system. A head up display device is a device that provides augmented reality (AR) by overlaying (superimposing) an image (a virtual object) on the actual view to the front of the vehicle, to add information provided by the image (the virtual object) to or to emphasize the actual view or a real object present in the actual view. Superimposing an image on the actual view to the front of the vehicle makes it possible to provide accurate driving assistance information while minimizing the need for an operator of a vehicle or the like to move the line of sight, thereby contributing to safe and comfortable vehicle operation.

Recent head up display devices perform a process to move (shift) the display position of an image in accordance with posture changes of a vehicle, to suppress relative positional misalignment between the image (the virtual object) and the actual view that occurs due to posture changes of the vehicle (see, for example, Patent Document 1). This allows the relative positional relationship between the image and the actual view to be maintained (allows positional misalignment between the image and the actual view to be suppressed), even if the posture of the vehicle changes. Thus, it is possible to harmonize the image with the actual view.

### PRIOR ART DOCUMENT

### Patent Document

Patent Document 1: WO 2020/208883

### SUMMARY OF INVENTION

### Problems to be Solved by the Invention

However, in the head up display device described in Patent Document 1, the vehicle posture is calculated based on an angular velocity detected by a gyro sensor, and a process to move the display position of an image (a correction process for the display position based on the angular velocity) is performed based on the calculated vehicle posture. Therefore, when the detected angular velocity becomes constant, a correction amount based on the angular velocity converges to 0 over time, and thus the display position of the image is no longer corrected.

For example, if the vehicle posture is tilted forward, for example, when the vehicle is decelerating, and the angular velocity becomes 0 (converges to 0) due to the deceleration, the correction process for the display position of the image ceases to be performed, and thus the image may be displayed at a display position shifted downward relative to the actual view and appear to be sunken. Such an image displayed as being sunken relative to the actual view may give a sense of visual incongruity to an operator.

The present disclosure has been made in consideration of the above-mentioned problems, and an object thereof is to provide a mobile body display system that corrects the display position of an image (a virtual object) when a mobile body is accelerated or decelerated, not to give a sense of visual incongruity to an operator.

### Solution to Problem

To solve the above problems, a mobile body display system according to a first embodiment is a mobile body display system for displaying an image on a display unit installed on a traveling direction side of a mobile body, such that the image is superimposed on an actual view on the traveling direction side, and includes an information acquisition means that acquires angular velocity information including information indicating an angular velocity of the mobile body, and acceleration information including information indicating acceleration of the mobile body, from a posture detection means installed on the mobile body, a control means that sets correction information for correcting a display position of an image to be displayed on the display unit, based on an angular velocity from the angular velocity information acquired by the information acquisition means and an acceleration from the acceleration information acquired a prescribed time before the time of acquisition of the angular velocity information by the information acquisition means, and a display position adjustment means that adjusts the display position of the image to be displayed on the display unit, based on the correction information set by the control means.

A mobile body display system according to a second embodiment that may be dependent on the first embodiment, includes a recording means that records, in chronological order, a plurality of pieces of the acceleration information acquired by the information acquisition means. In the mobile body display system according to the second embodiment, the control means extracts, from the recording means, a piece of the acceleration information acquired a prescribed time before the time of acquisition of the angular velocity information by the information acquisition means, and sets the correction information based on the acceleration from the extracted piece of the acceleration information and the angular velocity from the angular velocity information acquired by the information acquisition means.

In a mobile body display system according to a third embodiment that may be dependent on the first embodiment or the second embodiment, time from when the information acquisition means acquires the angular velocity information to when the control means sets the correction information using angular velocity from the angular velocity information and outputs the correction information to the display position adjustment means is shorter than time from when the information acquisition means acquires the acceleration information to when the control means sets the correction information using acceleration from the acceleration information and outputs the correction information to the display position adjustment means.

In a mobile body display system according to a fourth embodiment that may be dependent on any one of the first embodiment to the third embodiment, the prescribed time is varied to be longer when an amount of increase in the acceleration is larger and shorter when the amount of increase in the acceleration is smaller.

In a mobile body display system according to a fifth embodiment that may be dependent on any one of the first embodiment to the fourth embodiment, the prescribed time is set in advance for an individual mobile body.

### Effect of the Invention

According to the mobile body display system of the present disclosure, the display position of an image can be corrected when the mobile body is accelerating or decelerating, not to give a sense of visual incongruity to an operator.

### BRIEF DESCRIPTION OF THE DRAWINGS

FIG. 1 is a schematic diagram illustrating a simplified configuration of a vehicle display system according to an embodiment.

FIG. 2 is a block diagram illustrating a simplified configuration of a display control device according to an embodiment.

FIG. 3 is a flowchart illustrating processes of a display control unit according to an embodiment.

FIG. 4 shows graphs showing change in an acceleration value of a vehicle over time, change in vehicle posture over time, change in an angular velocity value over time, a correction amount based on angular velocity, a correction amount based on acceleration, a conventional correction state, and a correction state of the present disclosure.

### MODE FOR CARRYING OUT THE INVENTION

Hereinafter, a mobile body display system according to the present disclosure will be described in detail with reference to the drawings and by using a vehicle display system as an example. Note that the mobile body display system can be applied as a display system for mobile bodies, such as vehicles including four-wheeled vehicles and two-wheeled vehicles, watercrafts, aircrafts, agricultural machines, and construction machines.

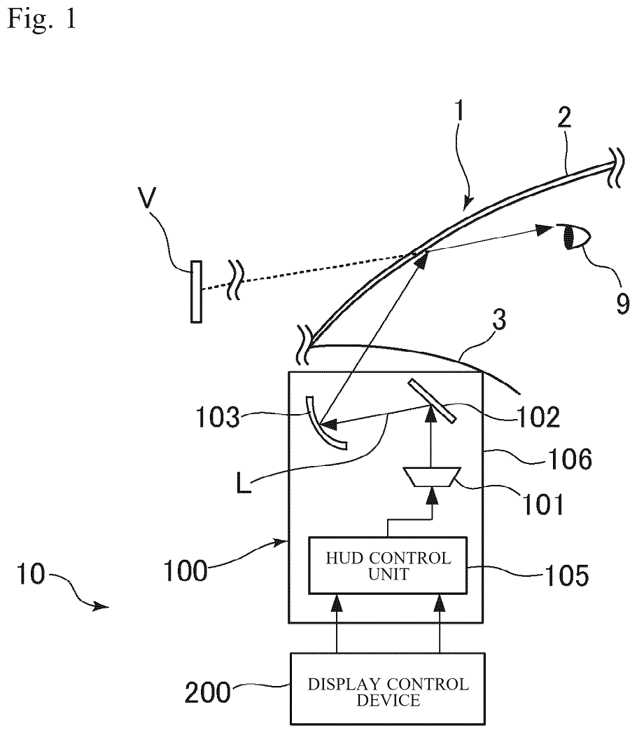

FIG. 1 is a schematic diagram illustrating a simplified configuration of a vehicle display system according to an embodiment. As illustrated in FIG. 1, a vehicle display system (a mobile body display system) 10 includes a head up display (HUD) device (a display position adjustment means) 100 and a display control device 200.

The HUD device 100 is installed in an instrument panel 3 of a vehicle (a mobile body) 1. The HUD device 100 has a display 101, a plane mirror 102, a concave mirror (the display position adjustment means) 103, and a HUD control unit (the display position adjustment means) 105, and is housed in a housing 106.

The display 101 is a device that outputs an image (a virtual object) to be visually recognized by an operator 9, as display light L in response to an instruction from the HUD control unit 105. The display 101 may be, for example, a thin film transistor (TFT) liquid crystal display or an organic electroluminescence (EL) display.

The plane mirror 102 is a mirror that reflects, toward the concave mirror 103, the display light L (the image: the virtual object) output from the display 101, and the concave mirror 103 is a mirror that further reflects the display light L reflected by the plane mirror 102 to emit the display light L toward a windshield (a display unit) 2. The concave mirror 103 functions as a magnifier, and magnifies the image (the virtual object) of the display light L output from the display 101 and project the magnified image onto the windshield 2 of the vehicle 1.

The operator 9 visually recognizes reflected light of the display light L projected onto the windshield 2, as the image (the virtual object) V. The image (the virtual object) V visually recognized by the operator 9 via the windshield 2 is displayed as being overlayed on the actual view outside (in front of) the windshield 2.

Note that, to make it easier for the operator 9 to visually recognize the image via the windshield 2, a projector or a screen forming a display surface may be installed on the instrument panel 3 or on the windshield 2.

The HUD control unit 105 performs a process to cause the display 101 to output an image (the display light L), based on image information received from a display control unit (a control means) 210 of the display control device 200, which will be described below. In addition, the HUD control unit 105 adjusts the display position of the image (the virtual object) to be projected onto the windshield 2 by adjusting the drawing position of the image in the display 101 based on correction information received from the display control unit 210.

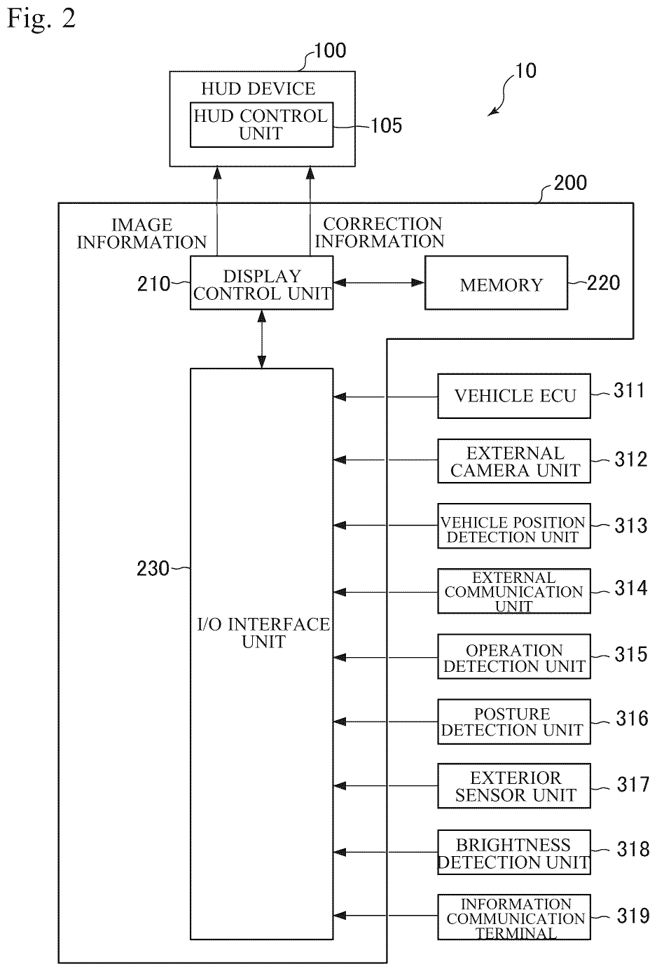

FIG. 2 is a block diagram illustrating a simplified configuration of the display control device 200. The display control device 200 includes the display control unit 210, a memory (a recording means) 220, and an I/O interface unit (an information acquisition means) 230. In the memory 220, image data (such as sign image data, arrow image data, and the like) for generating an image (a virtual object) V, a program in which processes of the display control unit 210 are recorded, and various data required for process decisions (threshold data, table data, etc., for example, table data that records adjustment amounts for the display 101 corresponding to angular velocity information and acceleration information described below), and the like are recorded. As the memory 220, a common recording medium such as a magnetic medium, a volatile memory, or a non-volatile memory is used.

The I/O interface unit 230 is connected to various devices installed in the vehicle 1, and thus the display control unit 210 can acquire various information from the various devices via the I/O interface unit 230. The I/O interface unit 230 can be connected to, for example, a vehicle electronic control unit (ECU) 311 that can acquire acceleration information, speed information, brake operation information based on the amount of power generated by a regenerative brake, and the like of the vehicle 1, an external camera unit 312 that can acquire information on surroundings of the vehicle 1 (for example, image information obtained by capturing the view to the front or the view to the rear of the vehicle), a vehicle position detection unit 313 that utilizes a global positioning system (GPS) or the like for detecting the position of the vehicle, an external communication unit 314 that transmits and receives various information via the internet or the like, an operation detection unit 315 that detects operation information such as the amount of steering of a steering wheel operated by the operator 9 and the amount of depression of a brake pedal and an access pedal, a posture detection unit (a posture detection means) 316 that can acquire acceleration information indicating the acceleration of the vehicle 1 and angular velocity information indicating the angular velocity of the vehicle 1, an exterior sensor unit 317 that can detect other vehicles, obstacles, and the like present around the vehicle, a brightness detection unit 318 that can detect the brightness outside the vehicle, and an information communication terminal 319 including a smartphone, a tablet, or the like.

Note that, for convenience of explanation, the I/O interface unit 230 according to the embodiment will be described in association with the posture detection unit 316 that can acquire acceleration information and angular velocity information of the vehicle 1.

The posture detection unit 316 is a device provided for the purpose of grasping and predicting change in the posture of the vehicle 1. An inertial measurement unit (IMU) is generally used as the posture detection unit 316. The IMU is equipped with a three axis (a roll axis: an axis extending in a front-rear direction of the vehicle 1, a pitch axis: an axis extending in a left-right direction of the vehicle 1, and a yaw axis: an axis extending in an up-down direction of the vehicle 1) angular velocity (gyro) sensor (deg/s), a three axis (an X axis: an axis extending in the front-rear direction of the vehicle 1, a Y axis: an axis extending in the left-right direction of the vehicle 1, and a Z axis: an axis extending in the up-down direction of the vehicle 1) acceleration sensor (m/s²), and the like, and can detect three-dimensional inertial movement (translational movement and rotational movement in three-orthogonal axis system). By the posture detection unit 316 connected to the I/O interface unit 230, the display control unit 210 can acquire acceleration information indicating the acceleration of the vehicle 1 and angular velocity information indicating the angular velocity of the vehicle 1. The posture detection unit 316 detects acceleration and angular velocity at prescribed intervals (a prescribed data rate, and outputs the acceleration information and the angular velocity information to the I/O interface unit 230.

The display control unit 210 performs a process to generate an image (a virtual object) to be projected onto the windshield 2 and output the image to the HUD control unit 105. For example, based on a road sign (such as a speed limit sign or a no entry sign) recognized from an image of the area in front of the vehicle captured by the external camera unit 312, the display control unit 210 acquires image data of the corresponding sign from the memory 220 and generates image information of an appropriate image V to be projected onto the windshield 2. Similarly, the display control unit 210 acquires image data indicating the speed of the traveling vehicle (image data indicating the traveling speed) from the memory 220 based on speed information acquired from the vehicle ECU 311, and generates image information of an image V. The image information generated by the display control unit 210 is output in real time to the HUD control unit 105 and projected onto the windshield 2 by the HUD device 100.

In addition, the display control unit 210 performs process to generate correction information for adjusting the display position of the image based on the angular velocity information and acceleration information from the posture detection unit 316 acquired via the I/O interface unit 230, and output the correction information to the HUD control unit 105. The HUD control unit 105 adjusts the display position of the image (the virtual object) to be projected onto the windshield 2 by adjusting the positions of the plane mirror 102 and the concave mirror 103 based on the correction information acquired from the display control unit 210.

Note that, information about a display position for when the vehicle 1 is horizontal to the road surface and there is no relative misalignment between the image to be projected onto the windshield 2 and the actual view (this display position is referred to as a “reference position”), is recorded in the memory 220 in advance. The display control unit 210 acquires the information about the reference position from the memory 220, calculates the amount of misalignment of the image relative to the reference position based on change in the posture of the vehicle 1, corrects this amount of misalignment, and thereby corrects the display position of the image (the virtual object).

In addition, based on the angular velocity information acquired from the posture detection unit 316, the display control unit 210 calculates a pitch angle indicating how much the front or rear part of the vehicle 1 is tilted relative to the vehicle 1 being in a horizontal state, a roll angle indicating how much the left or right part of the vehicle 1 is tilted relative to the vehicle 1 being in the horizontal state, and a yaw angle indicating the turning angle of the vehicle 1. Methods for calculating the pitch angle, the roll angle, and the yaw angle based on angular velocity information are known, and various methods can be used. For example, a calculation method using integral calculation of angular velocity and a calculation method using a Kalman filter are known. The pitch angle, the roll angle, and the yaw angle can also be calculated based on the acceleration information acquired from the posture detection unit 316, and methods for this calculation are also known. Thus, detailed explanations are omitted here. Note that in some embodiments, calculation of the roll angle and/or the yaw angle may be omitted.

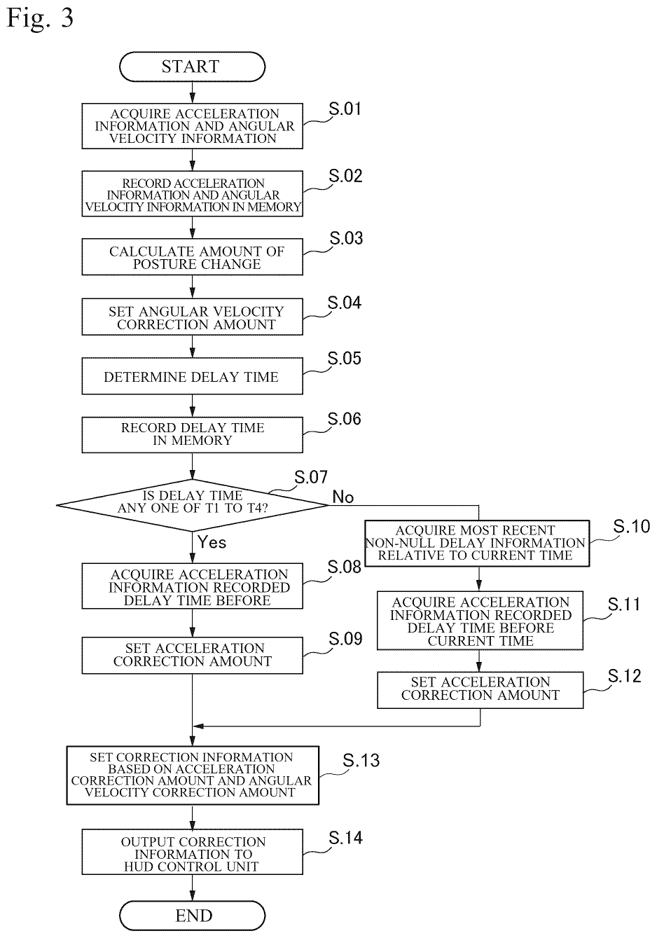

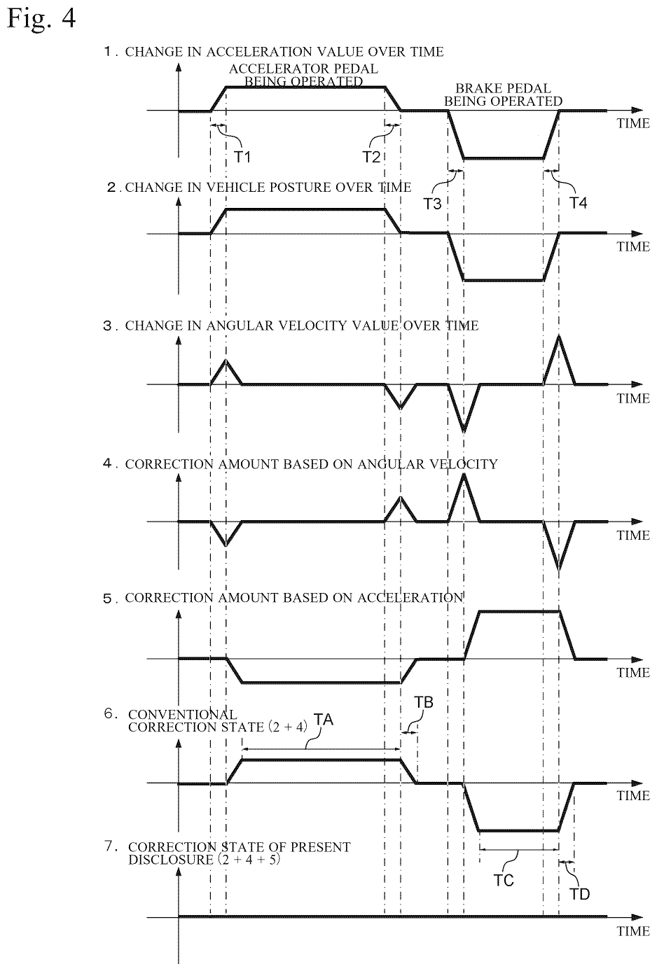

Next, a process in which the display control unit 210 corrects the display position of the image to be projected onto the windshield 2 based on the angular velocity information and the acceleration information will be described. FIG. 3 is a flowchart illustrating processes of the display control unit 210. FIG. 4 shows graphs showing change in an acceleration value of a vehicle over time, change in vehicle posture over time, change in an angular velocity value over time, a correction amount based on angular velocity, a correction amount based on acceleration, a conventional correction state, and a correction state of the present disclosure.

First, the display control unit 210 acquires acceleration information and angular velocity information of the vehicle 1 from the posture detection unit 316 via the interface unit 230 (S.01). Then, the display control unit 210 records the acquired acceleration information and angular velocity information in the memory 220 (S.02). Note that, as described above, the display control unit 210 acquires acceleration information and angular velocity information from the posture detection unit 316 at prescribed intervals, and repeatedly executes the processes illustrated in FIG. 3, as described below. Therefore, a plurality of pieces of acceleration information and angular velocity information acquired at different times (periods) are recorded in chronological order in the memory 220.

Next, the display control unit 210 calculates an amount of posture change of the vehicle 1 based on the acquired angular velocity information (S.03). The amount of posture change is information that numerically indicates how much the vehicle 1 is tilted relative to the road surface compared to the vehicle 1 in a horizontal state in situations such as when the vehicle is traveling. As an example, the display control unit 210 of the present disclosure calculates, as the amount of posture change, the pitch angle in the front-rear direction of the vehicle 1.

Next, to move the display position of the image in the up-down direction in accordance with an increase or decrease in the angular velocity, the display control unit 210 performs process to correct the display position of the image (the virtual object) based on the angular velocity information. The correction amount set by the display control unit 210 is a correction amount set in accordance with the angular velocity, and is therefore referred to as an angular velocity correction amount. The angular velocity correction amount indicates the amount of movement of the image to be moved in accordance with the angular velocity, which is expressed by, for example, the amount of adjustment of the drawing position of the image on the display 101.

If the front portion of the vehicle 1 is not tilted (if the pitch angle is 0 degrees), the image is projected (displayed) at the reference position on the windshield 2. If the pitch angle is detected from the angular velocity information (the pitch angle is not 0 degrees), the display control unit 210 determines how much the display position of the image is offset (moved (shifted)) from the reference position due to the pitch angle, and sets an adjustment amount (correction amount) for adjusting the drawing position of the image on the display 101 in accordance with the angular velocity. The display 101 adjustment amount (correction amount) to be set in accordance with the angular velocity is recorded in advance in the memory 220 as table data or the like. The display control unit 210 sets the angular velocity correction amount by determining the adjustment amount (correction amount) corresponding to the acquired angular velocity information based on the table data. (S.04) Next, the display control unit 210 performs a process of determining a “delay time (prescribed time)” for executing an “acceleration-based correction process” described below (S.05). First, situations in which the posture of the vehicle 1 changes in accordance with acceleration information are considered. As situations in which the posture of the vehicle 1 changes in accordance with acceleration information, the following states (1) to (4) may be assumed.
(1) A state where the acceleration value begins to increase as a result of the operator 9 depressing the accelerator pedal to accelerate the vehicle 1 in the vehicle 1 which is stopped or traveling at a constant speed (a state where the acceleration value gradually increases upward: a time T1 shown in “1. CHANGE IN ACCELERATION VALUE OVER TIME” in FIG. 4).
(2) A state after acceleration of the vehicle 1 begins to decrease as a result of the operator 9 releasing the accelerator pedal in the vehicle 1 being uniformly accelerated, and before the speed of the vehicle 1 becomes constant (a state where the acceleration value gradually decreases downward: a time T2 shown in “1. CHANGE IN ACCELERATION VALUE OVER TIME” in FIG. 4).
(3) A state where the acceleration value begins to decrease as a result of the operator 9 depressing the brake pedal to decelerate the vehicle 1 in the vehicle 1 being traveling at a constant speed (a state where the acceleration value gradually decreases downward: a time T3 shown in “1. CHANGE IN ACCELERATION VALUE OVER TIME” in FIG. 4).
(4) A state after acceleration of the vehicle 1 begins to increase as a result of the operator 9 releasing the brake pedal in the vehicle 1 being uniformly accelerated, and before the speed of the vehicle 1 becomes constant (a state where the acceleration value gradually increases upward: a time T4 shown in “1. CHANGE IN ACCELERATION VALUE OVER TIME” in FIG. 4).

The above-described states (1) to (4) are states in which the posture of the vehicle 1 changes, and therefore in these states, the angular velocity value detected by the posture detection unit 316 also increases or decreases (see the angular velocity values at the times T1 to T4 in “3. CHANGE IN ANGULAR VELOCITY VALUE OVER TIME” in FIG. 4). The display control unit 210 detects each of the states (1) to (4) and determines each of the times T1 to T4 shown in FIG. 4 as the delay time (the prescribed time).

FIG. 4 shows, from top to bottom, the above-mentioned “1. CHANGE IN ACCELERATION VALUE OVER TIME”, “2. CHANGE IN VEHICLE POSTURE OVER TIME”, the above-mentioned “3. CHANGE IN ANGULAR VELOCITY VALUE OVER TIME”, and “4. CORRECTION AMOUNT BASED ON ANGULAR VELOCITY”. In the state (1), while the operator 9 depresses the accelerator pedal to increase the acceleration (T1 in FIG. 4), the acceleration value gradually increases upward in “1. CHANGE IN ACCELERATION VALUE OVER TIME”, and the pitch angle, which indicates “2. CHANGE IN VEHICLE POSTURE OVER TIME”, also increases over time. Similarly, while the operator 9 depresses the accelerator pedal to increase acceleration (T1 in FIG. 4), the angular velocity shown in “3. CHANGE IN ANGULAR VELOCITY VALUE OVER TIME”, which is based on the angular velocity information, also gradually increases upward.

In this state, the pitch angle of vehicle 1 increases and the front part of vehicle 1 tilts upward, and thus the display control unit 210 corrects the display position of the image by moving (shifting) the display position downward in accordance with the angular velocity value shown in “3. CHANGE IN ANGULAR VELOCITY VALUE OVER TIME”. “4. CORRECTION AMOUNT BASED ON ANGULAR VELOCITY” in FIG. 4 shows the angular velocity correction amount for correcting (moving (shifting)) the display position of the image based on the angular velocity value.

Then, the operator 9 keeps the amount of depression of the accelerator pedal constant, and thus the acceleration value shown in “1. CHANGE IN ACCELERATION VALUE OVER TIME” becomes constant, and the pitch angle indicating “2. CHANGE IN VEHICLE POSTURE OVER TIME” also becomes constant. On the other hand, due to the constant amount of depression of the accelerator pedal, the angular velocity shown in “3. CHANGE IN ANGULAR VELOCITY VALUE OVER TIME” gradually decreases downward and becomes 0 (zero) (converges to 0).

The display control unit 210 detects, as the delay time (time T1), the time from when the acceleration value shown in “1. CHANGE IN ACCELERATION VALUE OVER TIME” starts to increase continuously from a constant value, to when becoming constant again.

Specifically, the display control unit 210 determines, based on the acceleration information acquired in the process of S.01, the delay time T1 by measuring the time from when the acceleration value starts to increase over time from a constant value, to when becoming constant again.

Alternatively, the delay time T1 may be determined by measuring time during which the acceleration value shown in “1. CHANGE IN ACCELERATION VALUE OVER TIME” gradually increases upward over time and which is time from when the angular velocity value shown in “3. CHANGE IN ANGULAR VELOCITY VALUE OVER TIME” starts to increase from a constant value over time, until just before starting to decrease.

Alternatively, the delay time T1 may be determined by measuring time from when the pitch angle value, which indicates “2. CHANGE IN VEHICLE POSTURE OVER TIME”, starts to increase from a constant value over time, to when becoming constant again.

Alternatively, the delay time T1 may be determined by measuring time during which the value of the pitch angle indicating “2. CHANGE IN VEHICLE POSTURE OVER TIME” gradually increases upward over time and which is time from when the angular velocity value shown in “3. CHANGE IN ANGULAR VELOCITY VALUE OVER TIME” starts to increase from a constant value over time, until just before starting to decrease.

The display control unit 210 performs process to determine the delay time T1 in the state (1) by using any of the methods described above. Similarly, the display control unit 210 performs processes to determine the delay times T2 to T4 in states (2) to (4) in addition to state (1). Note that, if the acceleration value remains constant or if the pitch angle, which indicates change in vehicle posture over time, remains constant, no increase in acceleration or pitch angle can be detected or measured, and therefore the delay time cannot be determined. In such a case where the delay time cannot be determined, the display control unit 210 sets the delay time to Null (empty information).

The display control unit 210 records the delay time determined in S.05 in the memory 220 (S.06). Note that, since the display control unit 210 repeatedly executes the processes illustrated in FIG. 3, as described above, the number of delay times recorded in the memory 220 is two or more, rather than one, and these delay times are recorded in chronological order. Therefore, even if there is a series of pieces of delay information set to Null and arranged in chronological order, for example, it is possible to detect a piece of the delay information that was recorded before the current time and to which information other than Null (T1 to T4) is set, because a plurality of pieces of delay information are recorded in chronological order.

The display control unit 210 determines whether the delay time determined at the current time is “any one of the times T1 to T4” (whether the delay time is other than Null) (S.07). If the delay time is “any one of the times T1 to T4” (if the delay time is not Null, Yes in S.07), the display control unit 210 acquires a piece of the acceleration information recorded the delay time (T1 to T4) before the current time, from pieces of the acceleration information recorded in the memory 220 (see process in S.02) (S.08). As described above, the plurality of pieces of acceleration information obtained at prescribed intervals are recorded in chronological order in the memory 220, and the display control unit 210 extracts/acquires a piece of acceleration information that has been recorded at a period preceding by a number obtained by dividing the delay time by a time length of one period (a piece of the acceleration information acquired a prescribed time before). The display control unit 210 sets an acceleration correction amount for correcting (moving (shifting)) the display position of the image based on the acceleration value from the acquired piece of the acceleration information (S.09). Specifically, if the acceleration value is positive, the display control unit 210 sets the correction amount such that the display position of the image moves (shifts) downward, and if the acceleration value is negative, sets the correction amount such that the display position of the image moves (shifts) upward.

Here, the correction amount set by the display control unit 210 is referred to as an acceleration correction amount because it is a correction amount set based on the acceleration value. The acceleration correction amount is a correction amount that indicates the amount of movement of the image to be moved in accordance with the acceleration value, expressed by, for example, the amount of adjustment of the drawing position of the image on the display 101. The display control unit 210 determines, based on the posture state (the pitch angle) of the vehicle 1, how much the display position of the image needs to be moved (shifted) from the reference position, and sets an adjustment amount (the correction amount) for adjusting the drawing position of the image in the display 101. The adjustment amount (correction amount) of the display 101 to be set in accordance with the acceleration is recorded in advance in the memory 220 as table data or the like. The display control unit 210 determines, based on the table data, the adjustment amount (correction amount) corresponding to the acquired piece of the acceleration information, and thereby sets the acceleration correction amount.

On the other hand, if the delay time is not “any one of the times T1 to T4” (if the delay time is set to Null, No in S.07), the display control unit 210 reads out, from the memory 220 recording the plurality of pieces of delay information, a piece of delay information other than Null that was recorded before the current time and that was recorded at a time closest to the current time (most recently recorded) (S.10). Then, the display control unit 210 acquires, from the memory 220, a piece of acceleration information that was recorded the delay time from the read piece of the delay information before the current time (S.11). The display control unit 210 sets, based on the acceleration value from the acquired piece of the acceleration information, an acceleration correction amount for moving the display position of the image (S.12).

In FIG. 4, change in the acceleration correction amount over time is shown as “5. CORRECTION AMOUNT BASED ON ACCELERATION”. The acceleration correction amount is for correcting the display position of the image in accordance with increase or decrease in acceleration shown in “1. CHANGE IN ACCELERATION VALUE OVER TIME”, such that, if acceleration increases, the correction amount is decreased, and if acceleration decreases, the correction amount is increased. Here, as shown in FIG. 4, the acceleration correction amount is configured such that correction based on the acceleration value is delayed by the delay times T1 to T4. In this way, by executing the “acceleration-based correction process” after the delay times T1 to T4 have elapsed (by delaying the execution timing of the “acceleration-based correction process” by the delay time), the acceleration-based correction process can be started at the timing when the delay time has elapsed after the angular velocity-based correction process has been performed.

Therefore, even if the acceleration derived from the angular velocity information acquired by the posture detection unit 316 converges to 0 over time, it is possible to increase “5. CORRECTION AMOUNT BASED ON ACCELERATION” to compensate for the decrease in “4. CORRECTION AMOUNT BASED ON ANGULAR VELOCITY”. Therefore, even if the correction of the display position of the image using “4. CORRECTION AMOUNT BASED ON ANGULAR VELOCITY” has ended when the vehicle posture is inclined and is not horizontal with respect to the road surface, the correction process using “5. CORRECTION AMOUNT BASED ON ACCELERATION” can be performed. Therefore, it is possible to prevent the image from moving significantly upward or downward relative to the reference position, and to prevent the image display from giving a sense of visual incongruity to the operator 9.

“6. CONVENTIONAL CORRECTION STATE” shown in FIG. 4 is a graph showing the amount of misalignment between the display position of an image and the reference position when the display position of the image is corrected only by the angular velocity-based correction process (using only angular velocity correction information). “7. CORRECTION STATE OF PRESENT DISCLOSURE” shown in FIG. 4 is a graph showing the amount of misalignment between the display position of an image and the reference position when correction is performed using not only the angular velocity-based correction process (the angular velocity correction information) but also the acceleration-based correction process (acceleration correction information).

As described above, in the conventional correction state, once the angular velocity value shown in “3. CHANGE IN ANGULAR VELOCITY VALUE OVER TIME” converges to 0 (zero), no correction is made to the display position of the image even if the vehicle posture is not horizontal to the road surface (the pitch angle is not 0). For this reason, during a time TA in “6. CONVENTIONAL CORRECTION STATE”, the image is shifted upward with respect to the actual view, and appears to the operator 9 to float. On the other hand, when “4. CORRECTION AMOUNT BASED ON ANGULAR VELOCITY” subsequently starts to converge to 0 (a time TB), the image appears to the operator 9 to move.

Similarly, when the operator 9 operates the brake pedal and the acceleration becomes constant (a time TC), the image is shifted downward with respect to the actual view, and appears to the operator 9 to be sunken. Further, when “4. CORRECTION AMOUNT BASED ON ANGULAR VELOCITY” subsequently starts to converge to 0 (a time TD), the image appears to the operator 9 to move.

In this way, in the conventional correction state, the display position of the image changes relatively greatly in accordance with the posture state of the vehicle, which gives a sense of visual incongruity to the operator 9. In contrast, in “7. CORRECTION STATE OF PRESENT DISCLOSURE” shown in FIG. 4, correction based on the acceleration value is performed at the timing when a delay time has elapsed after correction based on the angular velocity is performed. Thus, it is possible to maintain the display position of the image in a stable state regardless of the posture state of the vehicle 1 (maintain the amount of misalignment between the display position of the image and the reference position, at 0 (zero)).

After setting the acceleration correction amount in the process of S.09 or S.12 in FIG. 3, the display control unit 210 combines information on the acceleration correction amount (the acceleration correction information) set in S.09 or S.12 with information on the angular velocity correction amount (the angular velocity correction information) set in S.04 to set the correction information (S.13). Thereafter, the display control unit 210 outputs the set correction information to the HUD control unit 105 (S.14), and ends the processing shown in FIG. 4. The HUD control unit 105 adjusts the display position of the image to be projected onto the windshield 2 by adjusting the drawing position of the image on the display 101 based on the correction information acquired from the display control unit 210.

After the process shown in FIG. 4 ends, the display control unit 210 repeatedly executes the processing shown in FIG. 4. Repeatedly executing the processing shown in FIG. 4 by the display control unit 210 makes it possible to quickly correct the display position of the image in accordance with changes in the posture of the vehicle 1, and reduce a sense of visual incongruity felt by the operator 9.

The mobile body display system of the present disclosure has been described in detail above with reference to the drawings, but the mobile body display system of the present disclosure is not limited to the contents of the description of the embodiments. For example, in the display control unit 210 of the present disclosure, the angular velocity-based correction process is executed without delay, while the acceleration-based correction process is executed after the delay time has elapsed. However, the timing of executing the angular velocity-based correction process is not limited to this configuration.

In the mobile body display system of the present disclosure, the correction based on acceleration may be started immediately after the correction based on angular velocity (more specifically, at the timing when the angular velocity value starts to decrease after increase). Thus, there may be a delay or the like between the time when the control means (the display control unit 210) acquires the angular velocity information and the time when the control means sets the correction information using the angular velocity information and outputs the correction information to the display position adjustment means (the HUD control unit 105, the display 101) (or the time when the correction process for the display position of the image is performed according to the correction information) (for convenience, these times will be referred to as a “ first time”).

However, since the delay time needs to be provided between the start of correction process based on the correction information using angular velocity and the start of correction process based on the correction information using acceleration, the first time is shorter than time from when the control means (the display control unit 210) acquires acceleration information to when the control means sets correction information using the acceleration information and outputs the correction information to the display position adjustment means (the HUD control unit 105, the display 101) (or until the correction process for the display position of the image is performed according to the correction information) (for convenience, these times will be referred to as a “second time”). By making the first time as short as possible, it becomes possible to quickly correct position display of the image in accordance with changes in the posture of the vehicle, and to reduce a sense of visual incongruity due to display state of the image.

Furthermore, in the vehicle display system 10 of the present disclosure, as examples, cases have been described in which the delay time (the prescribed time) until the acceleration-based correction process is started is determined based on the time from when the acceleration starts to increase or decrease from a constant value, to when the acceleration becomes constant again, and/or the like. Therefore, when the amount of increase or decrease in acceleration is small, the delay time becomes short, and when the amount of increase or decrease in acceleration is large, the delay time becomes long. That is, the delay time may change depending on the amount of increase or decrease in acceleration, and may also change depending on the time it takes for the acceleration to increase or decrease from a certain value to another value (for example, the slope of the increase or decrease in acceleration). Therefore, the display control unit 210 of the present disclosure can vary the delay time depending on the amount of increase or decrease in acceleration, or the state of change in the amount of increase or decrease in acceleration, and can flexibly adjust the time until the display position of the image is corrected.

Furthermore, in the vehicle display system 10 of the present disclosure, examples have been described in which the delay time (the prescribed time) is determined by time from when the acceleration starts to increase or decrease from a constant value to when becoming constant, or by time from when the pitch angle of the vehicle 1 starts to increase from a constant value to when becoming constant. However, the delay time is not limited to being set and determined by these methods.

Change in vehicle posture caused by operation of the accelerator pedal or the brake pedal has characteristics specific to each individual vehicle. For example, change in vehicle posture may vary depending on the characteristics of the suspension, the weight, and/or the like of each individual vehicle. On the other hand, it is known that in vehicles having similar weights and suspension structures, a certain pedal operation causes a certain change in posture, and thus it is possible to set and determine the delay time (the prescribed time) for each vehicle in advance based on experimental values. Therefore, it is possible to investigate change in the posture, etc. caused by a pedal operation for each vehicle, in advance through experiments or the like, to determine in advance the delay time (the prescribed time) for the certain operation for each vehicle.

Specifically, the delay times in the states (1) to (4) described in the present disclosure can be determined through experiments for each vehicle and recorded in advance in the memory 220, so that the display control unit 210 can read the delay time from the memory 220 for each occurrence of any of the states (1) to (4) and perform the correction process for the display position of the image as shown in FIG. 4.

Furthermore, in the vehicle display system 10 of the present disclosure, the delay time is determined based on the acceleration information and/or the like, detected by the posture detection unit 316, but the acceleration information used to determine the delay time is not limited to that detected by the posture detection unit 316. For example, acceleration information determined by the vehicle ECU 311 can be used.

### DESCRIPTION OF REFERENCE NUMERALS

1 Vehicle (mobile body)
2 Windshield (display unit)
3 Instrument panel
9 Operator
10 Vehicle display system (mobile body display system)
100 HUD device (display position adjustment means)
101 Display (of HUD device) (display position adjustment means)
102 Plane mirror (of HUD device)
103 Concave mirror (of HUD device)
105 HUD control unit (of HUD device) (display position adjustment means)
106 Housing (of HUD device)
200 Display control device
210 Display control unit (of display control device) (control means)
220 Memory (of display control device) (recording means)
230 I/O interface unit (of display control device) (information acquisition means)
311 Vehicle ECU
312 External camera unit
313 Vehicle position detection unit
314 External communication unit
315 Operation detection unit
316 Posture detection unit (posture detection means)
317 Exterior sensor unit
318 Brightness detection unit
319 Information communication terminal
T1 to T4 Delay time (prescribed time)

1. A mobile body display system for displaying an image on a display unit installed on a traveling direction side of a mobile body, such that the image is superimposed on an actual view on the traveling direction side, the mobile body display system comprising:
an information acquisition means that acquires angular velocity information including information indicating an angular velocity of the mobile body, and acceleration information including information indicating acceleration of the mobile body, from a posture detection means installed on the mobile body;
a control means that sets correction information for correcting a display position of an image to be displayed on the display unit, based on an angular velocity from the angular velocity information acquired by the information acquisition means and an acceleration from the acceleration information acquired a prescribed time before the time of acquisition of the angular velocity information by the information acquisition means; and
a display position adjustment means that adjusts the display position of the image to be displayed on the display unit, based on the correction information set by the control means.

2. The mobile body display system according to claim 1, comprising a recording means that records, in chronological order, a plurality of pieces of the acceleration information acquired by the information acquisition means, wherein
the control means
extracts, from the recording means, a piece of the acceleration information acquired a prescribed time before the time of acquisition of the angular velocity information by the information acquisition means, and
sets the correction information based on the acceleration from the extracted piece of the acceleration information and the angular velocity from the angular velocity information acquired by the information acquisition means.

3. The mobile body display system according to claim 1, wherein
time from when the information acquisition means acquires the angular velocity information to when the control means sets the correction information using angular velocity from the angular velocity information and outputs the correction information to the display position adjustment means is shorter than
time from when the information acquisition means acquires the acceleration information to when the control means sets the correction information using acceleration from the acceleration information and outputs the correction information to the display position adjustment means.

4. The mobile body display system according to claim 1, wherein the prescribed time is varied to be longer when an amount of increase in the acceleration is larger and shorter when the amount of increase in the acceleration is smaller.

5. The mobile body display system according to claim 1, wherein the prescribed time is set in advance for an individual mobile body.
